(19) United States
(12) Patent Application Publication
(10) Pub. No.: US 2008/0284936 A1
(43) Pub. Date: Nov. 20, 2008

(54) Lcd-Backlighting Unit with Improved Cooling Facilities

(75) Inventors: Cornelis Johannes Mies, Eindhoven (NL); Cornelis Versluijs, Eindhoven (NL); Johannes Antonius Maria Martina Van Uijtregt, Eersel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,894

(22) PCT Filed: Jun. 13, 2005
(86) PCT No.: PCT/IB2005/051947

§ 371 Date: Dec. 19, 2006

(30) Foreign Application Priority Data
Jun. 22, 2004 (EP) 04102856.4

(51) Int. Cl. G02F 1/1333

(52) U.S. Cl. 349/58

(57) ABSTRACT

The invention relates to a backlight module for backlighting an LCD-display unit, comprising holding means for holding a number of substantially longitudinal fluorescent lamps, wherein each of the lamps comprises a glass envelope, supply means for energizing said lamps, and cooling means for removing at least part of the heat developed by the lamps, wherein the cooling means comprise at least a first metal heat-conducting body which is thermally coupled to the glass envelope of at least one the lamps, and wherein the cooling means are in contact with only a limited surface area of the glass envelope of said at least one lamp. The provision of a heat-conducting body renders it possible to relocate the control mechanism further away, so that a screening of the light-emitting surface of the lamp is reduced. This holds good for any possible control equipment and for other voluminous parts of the heat-conducting systems.

The invention relates to a backlight module for backlighting an LCD-display unit, comprising holding means for holding a number of substantially longitudinal fluorescent lamps, each of the lamps comprising a glass envelope, supply means for energizing said lamps, and cooling means for removing at least part of the heat developed by the lamps.

Such a backlight module is disclosed in U.S. Pat. No. 4,978,890.

In this prior art document, a Peltier element is directly coupled to the glass of the lamp envelope, apart from a heat-conducting compound that is provided between the glass of lamp and the Peltier element. The cooling system covers a substantial portion of the light-radiating part of the lamp, screening off light emitted by the lamp. This is caused not only by the surface area of the heat-conducting compound on the glass, but also by the presence of the voluminous Peltier element.

The object of the invention is to provide a cooling system for a backlight module of the kind referred to above which avoids screening-off of the light emitted by the lamp.

This object is achieved in that the cooling means comprise at least a first metal heat-conducting body which is thermally coupled to the glass envelope of at least one of the lamps, and in that the cooling means are in contact with only a limited surface area of the glass envelopes of said at least one lamp.

The provision of a metal heat-conducting body offers the possibility to relocate any control mechanism further away so that the screening of the light-emitting surface of the lamp is reduced. This does not only hold for any possible control equipment, but also for any other voluminous parts of the heat-conducting systems, such as heat sinks.

The use of a metal heat-conducting body also offers the possibility to use only a small contact area with the glass envelope. This again leads to a reduction in the coverage of the light-emitting surface and in the amount of heat to be removed.

It is noted in this respect that the first metal heat-conducting body does not necessarily have to be in contact with the glass envelope; it is also possible to use a heat-conducting paste or a heat-conducting pad to provide a heat transport between the glass envelope and the first metal heat-conducting body. It is important, however, that the metal heat-conducting body is close to the lamp envelope.

The luminous efficacy of a fluorescent lamp, and in particular that of a HCFL-lamp, is highly dependent on the temperature of the so-called ‘cold spot’ in the lamp. The cold spot is a spot in the gas-filled envelope of the lamp in which the coldest temperature of the lamp prevails. The temperature thereof is important for the balance of the mercury between its liquid and gaseous states. The inventors have found that a temperature of about 45° C. at the ‘cold spot’ leads to an optimum efficacy of the lamp. The temperature of other parts of the lamp appear to be less relevant for the operation and the efficacy of the lamp. To take account of this phenomenon, the cooling means are adapted to create a cold spot in the lamp, leading to a preferred embodiment.

A preferred embodiment provides the feature that the cooling means are connected to a metal or ceramic part extending through the lamp envelope. This feature gives a very efficient thermal coupling between the part of the lamp to be cooled, that is commonly the cold spot, and the cooling means. It requires, however, a provision in the lamp itself.

Within this embodiment, it is preferred that the cooling means are connected to the metal part located at one of the ends of the lamp envelope, as this gives a good connection to the cooling means without screening off any portion of the light-emitting lamp part.

According to another embodiment, the lamp comprises an exhaust tube, and the cooling means are adapted to be in contact with the exhaust tube.

This embodiment avoids the problems with the covering of the light-emitting surface of the lamp, as the exhaust tube is usually present within the lamp cap, where no light emission takes place. Furthermore, it has been found that the presence of the cold spot in the exhaust tube or in the vicinity thereof leads to the same advantageous results as it does in any other location in the lamp.

The exhaust tube is a truncated glass tube. The glass tube is used to evacuate the lamp during manufacture. After evacuation, the tube is fused to be closed, resulting in a truncated stem. This implies that the shape thereof may be irregular or in any case non-cylindrical. Despite this shape, the invention provides an efficient removal of heat through the application of a thermally conducting paste which is arranged between the exhaust tube of the lamp and the first metal heat-conducting body of the lamp. This paste may adapt to any shape so as to compensate for any irregularities in the exhaust tube.

According to a preferred embodiment, the first metal heat-conducting body comprises an annular body that extends around the exhaust tube, and that is in contact with a second metal heat-conducting body. The presence of an annular body makes the surface area of the exhaust tube available for the transport of heat. This first metal heat-conducting body functions as an interface between the exhaust tube and the other parts of the cooling system.

This interface function is optimized when the first metal heat conducting-body comprises a substantially cylindrical sleeve which is open at both ends. Here the substantially cylindrical sleeve provides a large surface area in contact with the heat-conducting paste and the exhaust tube. The open ends avoid any contact between the distal end of the exhaust tube, which is very fragile, and any other part or paste which may damage the distal end of the exhaust tube.

A further optimization is achieved in that a flange arranged coaxially with the annular body is in contact with the second metal heat-conducting body, and in that the sleeve and the flange form a unitary body. Here the flange provides a large surface area for contact with the second metal heat-conducting body, while the transfer of heat from the exhaust tube to the other part of the body is achieved by making use of a unitary body.

To transport the heat further away from the lamps, the second heat-conducting body is formed by a metal finger thermally connected to a heat-conducting rod. Here the heat-conducting rod itself functions as a heat sink or is connected to a heat sink. The conduction of the heat further away from the lamp may be implemented in numerous ways; it is not a part of the present invention.

Generally but not exclusively, lamps used in the unit according to the invention comprise lamp caps at both ends. The stem of the lamp is usually located within one of the lamp caps, as is the first heat-conducting body. To make a good contact with the primary metal heat-conducting element, the second heat-conducting body extends through a lamp cap arranged at the end of the lamp at which the stem is located.

LCD-display units usually have a rectangular shape. This shape requires a number of mutually parallel longitudinal lamps to obtain an even backlighting. It is efficient to make use of the same heat-conducting path for cooling all lamps, so that each of the lamps is preferably connected to the same heat-conducting rod by means of a metal finger.

Some lamps of the module will be hotter than others. When the LCD-screens are used in a vertical position, as is common, the upper lamps will be hotter than the lower lamps. The presence of other heat generating components may also lead to a higher temperature of some lamps. To compensate for this effect, it is attractive to provide a better cooling of the hotter lamps. This is achieved in that the heat-conducting capacity of each of the fingers is adapted to the expected temperature of the lamp. Therefore, some of the fingers have a larger cross section than others.

Depending on the construction of the apparatus in which the LCD-unit is integrated, different ways of disposing of the heat withdrawn from the lamps may be used. As stated above, it may be possible to use a metal heat-conducting rod to remove the heat from the vicinity of the lamps; however, it is alternatively possible to make use of ventilation, either forced or natural. To serve the latter situations, the cooling means may comprise a heat sink connected to at least one of the metal lamp caps arranged at the two ends of the lamp. It is again possible in this configuration to enjoy the advantages of the invention: heat sinks are usually large elements which will lead to a screening of the light-emitting parts of the lamps and hence to a lowering of the efficiency when they are arranged in the vicinity of the light-emitting parts of the lamps. The invention renders it possible to arrange the heat sinks at a distance from at least the light-emitting parts of the lamps, allowing an unhampered emission of light.

A second series of embodiments provides the feature that the cooling means comprise a heat sink connected to at least one of the metal lamp caps arranged at the two ends of the lamp. This utilizes the fact that the lamp caps are in intimate contact with the glass of the lamp envelope. In this embodiment the lamp caps function as first metal heat-conducting elements. The ‘cold spot’ will then be located in the position where the lamp caps contact the glass.

This second series of embodiments may incorporate the feature that the heat sink comprises a hollow disc extending around the lamp caps. The provision of the hollow disc around the lamp cap provides a good contact with the lamp cap, while the disc shape is well adapted to be cooled by a gas flow. The construction is also relatively simple, resulting in a low cost price.

In the embodiment mentioned above, a lamp cap of each lamp is provided with its own heat sink. It is alternatively possible, however, to use a lamp cap which is intimately connected to the heat sink. This construction allows the use of a single heat sink for a plurality of lamps. This may be implemented in that the heat sink comprises a clamp connected to the lamp caps. It is alternatively possible, however, to connect the lamp caps to a common heat sink by means of the metal fingers of a preceding embodiment.

In the embodiments mentioned above, the cooling means are arranged to function at the ends of the generally longitudinal lamps. It is also possible in principle to provide cooling means which are in contact with the light-emitting middle sections of the lamps. This is achieved in that the cooling means are adapted to be in contact with the cylindrical part of the lamp envelope.

This seems contrary to the object of the invention explained above. However the application of a cold spot generally requires only a small contact area between the glass of the lamp and the cooling means. Furthermore, it is possible to provide the cooling means at the side of the lamp opposite the LCD-screen, which results in a limited direct screening effect. Of course the cooling means will have some negative effect on the amount of effective light directed towards the LCD-screen, as a reflector will usually be present at the side of the lamps opposite the LCD-screen, but, as was noted above, the area of contact between the cooling means and the lamp glass can be made comparatively small, so that the screening effect can be minimized.

A more specialized embodiment provides the feature that the metal heat-conducting body is a part of a metal box in which the lamps are provided, and that a heat-conducting pad is provided between each of the lamps and the part of the metal box. The metal box can again act as a heat sink here, and preferably also as a reflector, resulting in a substantial reduction of the number of parts and hence to a lower cost price.

Preferably, the metal box is thermally connected to at least a part of a housing of the apparatus in which the backlight unit is accommodated. The function of a heat sink is transferred from the metal box to the housing of the apparatus of which the LCD-unit forms part. This also leads to a reduction of the number of parts.

The luminous efficacy of the HCTL-lamps is highly dependent on the temperature of the ‘cold spot’. It is therefore of the utmost importance to operate the lamp at the optimum temperature. For a required luminous flux, which is dictated by the properties of the LCD-screen, this minimizes the energy consumption and the generation of heat by the lamps, resulting in a lower cooling capacity. However, the conditions under which the lamps operate may vary widely, first as a consequence of ambient temperature, but also of the processes taking place in the apparatus itself. It is accordingly advantageous to operate some kind of temperature control, which can be implemented by making the thermal conductivity of the cooling means dependent on the temperature.

Preferably, the cooling means comprise a Peltier element which is connected to a temperature-dependent control unit. Although the use of a Peltier element is known per se for numerous cooling applications, even for lamp units, as described in U.S. Pat. No. 4,978,890, the size of a Peltier element is such that it cannot be easily applied in the configuration according to the present invention. Therefore it is preferred that the Peltier element, which is also known as a thermo-electric element, be applied in the embodiments in which the cooling means are connected to the ends of the lamp.

However, there are other possibilities to execute control of the heat flow through the cooling means. According to a preferred embodiment, the cooling means comprise two heat-conducting elements that are in mutual contact via a coupling surface whose thermal conductivity is controllable through adjustment of the position of one of the elements. This embodiment avoids the constant use of energy of a Peltier element. Energy is obviously needed to generate the relative movement of the parts, but this energy is only required when a movement takes place, and not constantly as in the case of a Peltier element.

Again this construction may be bulky, but the arrangement at the ends of the lamps eliminates the problems caused by screening.

The above embodiment may be implemented by the provision of two heat-conducting elements that are in mutual contact via a coupling surface whose thermal conductivity is controllable through adjustment of the position of one of the elements.

In the implementation mentioned above, control takes place through a control of the surface area of the coupling surface. It is alternatively possible, however, to control the length perpendicular to the control surface of a coupling part. This is implemented by cooling means which comprise two heat-conducting elements which are separated by an air gap, wherein the width of the air gap is controllable through adjustment of the position of one of the elements

The control of the thermal conductivity of the path may take place through the ambient temperature, the cooling means comprising a bimetal as a control element. This control method can be executed in combination with all temperature control methods mentioned above. An important advantage of a bimetal element is the fact that it uses its surroundings as an energy source, obviating the need for a special energy source. It is alternatively possible, however, to position the control element such that its temperature is coupled to the temperature of a part of the lamps.

The unit as described above may be used to function as a backlight for an LCD-screen. The unit may be integrated to a major extent to simplify the construction of the combination, for instance by using the same frame for both the backlight unit and the LCD unit.

An LCD display may be operated in a scanning mode which reduces inter alia blur in dynamic images. The scanning mode implies that the display has a dark period. To obtain the same overall impression of brightness for the human eye, the brightness during the remaining time must be increased. This puts a greater thermal strain on the lamps, leading to a greater burden on the cooling unit, so that the advantages of the invention are more prominent in this application.

The LCD-screen according to the invention may be used in TV-sets for home use, screens for use with PCs, screens in switchboards of control rooms, in vehicles, ships or planes, and in numerous other applications.

The embodiment in which metal parts extends though the envelope of the lamp requires that the lamp is provided with a metal part extending through the envelope and adapted to be in contact with cooling means when mounted in a module according to the invention.

The invention will now be elucidated with reference to the following drawings, in which:

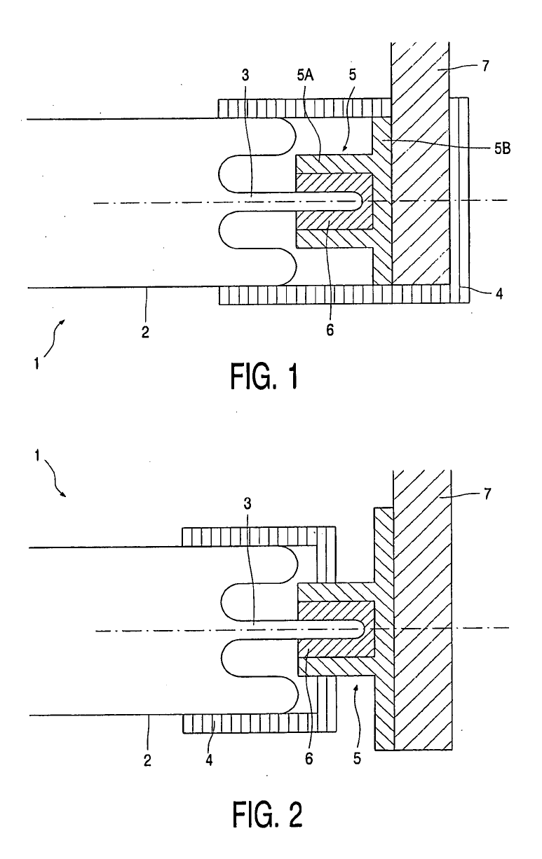

FIG. 1 is a cross-sectional view of an end of a HCFL lamp, wherein a cooling finger extends into the lamp cap;

FIG. 2 is a cross-sectional view of an end of a HCFL lamp, wherein a cooling finger is located outside the lamp cap;

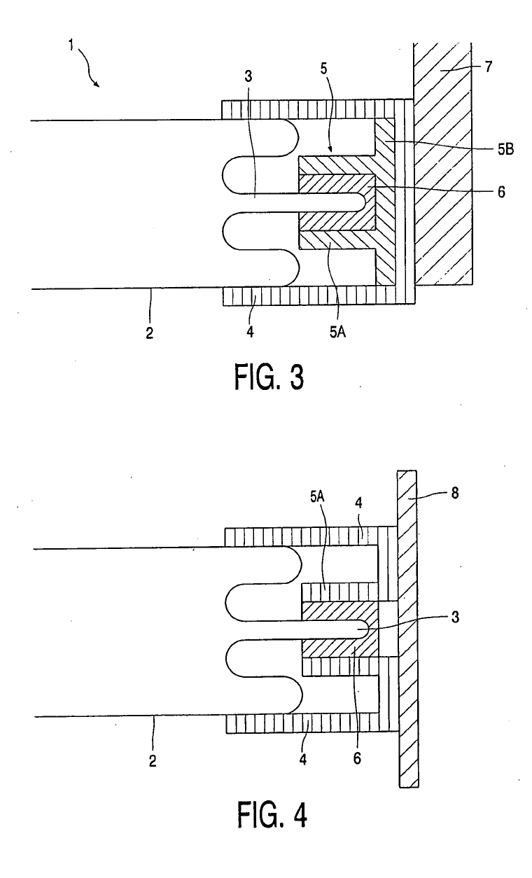

FIG. 3 is a cross-sectional view of an end of a HCFL lamp, wherein a cooling finger is located outside the lamp cap, and wherein the lamp cap functions as part of the cooling system;

FIG. 4 is cross-sectional view of an end of a HCFL lamp, wherein a heat sink is connected to the lamp cap;

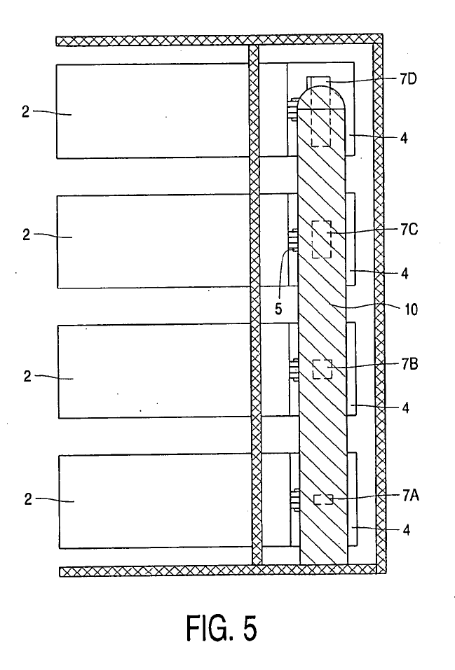

FIG. 5 is a schematic elevated view of a backlight unit according to the invention in which cooling fingers of different sizes are located;

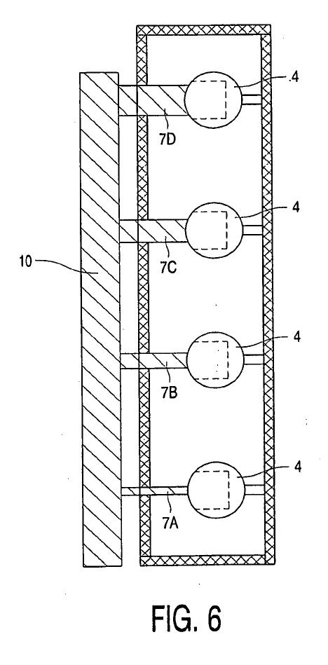

FIG. 6 is a schematic side elevation of the backlight unit depicted in FIG. 5;

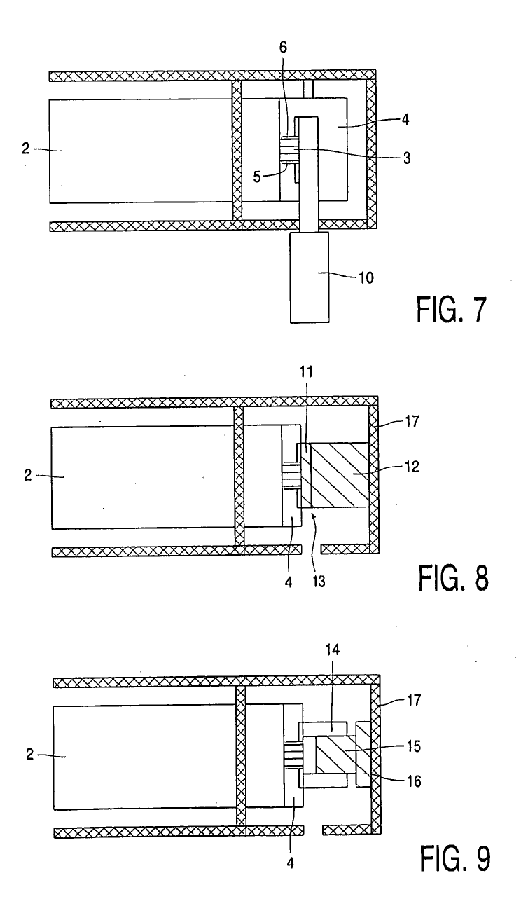

FIG. 7 is a schematic plan view of the backlight unit depicted in FIGS. 5 and 6;

FIG. 8 is a schematic cross-sectional view of a lamp end, wherein means for the control of the thermal flow have been arranged;

FIG. 9 is a view similar to that of FIG. 8, wherein other means for the control of the thermal flow have been provided;

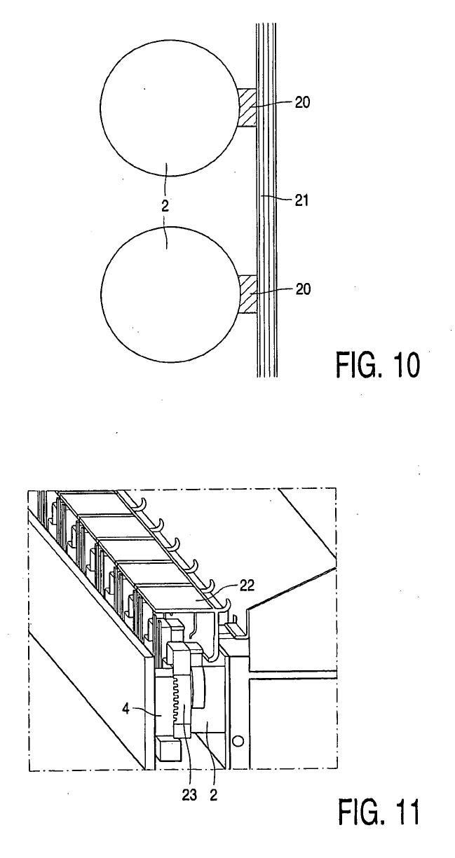

FIG. 10 is a cross-sectional view of a backlight unit, wherein a heat-conducting pad has been arranged between the lamps and a metal heat-conducting part located at the rear of the lamps;

FIG. 11 is a schematic perspective view of an embodiment of the invention, wherein heat sinks have been provided at the lamp caps; and

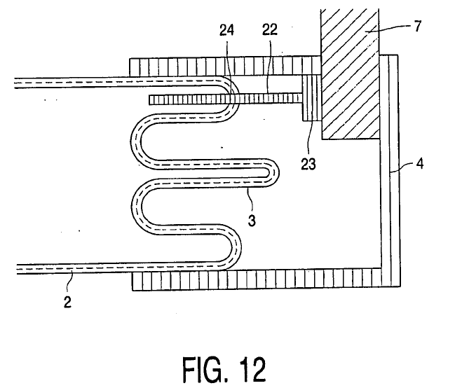

FIG. 12 is a cross-sectional view of a modification of the embodiment depicted in FIG. 1.

FIG. 1 shows the end of a HCFL tubular lamp 1 which forms part of a backlight unit for a visual display unit not depicted in any detail in the drawing. The tubular lamp 1 comprises a glass envelope 2, at one end whereof an exhaust tube 3 is formed during manufacture of the lamp. The exhaust tube is used for evacuating the lamp and is closed by fusion during manufacture. A lamp cap 4 is provided, surrounding part of the cylindrical section of the lamp, which lamp cap may be made of metal or plastic or a combination thereof. The lamp cap comprises connection means (not shown) for connecting the electrodes to respective contact points at the ends of the caps. These connections and the contacts do not form a part of the invention and will not be described any further.

A first metal heat-conducting element 5 is arranged within the lamp cap such that it surrounds a substantial portion of the exhaust tube 3. As the shape of the exhaust tube is usually not very well reproducible, it is not possible to arrange this first heat-conducting element 5 so as to be in contact with the exhaust tube 3 over a substantial surface area. Therefore, the first heat-conducting element comprises a sleeve-shaped part 5A of which the inner diameter is greater than the greatest radial dimension of the exhaust tub. The space between the sleeve-shaped part 5A and the exhaust tube is filled with a heat-conducting paste 6. The first heat-conducting element 5 further comprises a flange 5B. This flange 5B preferably has a circular shape to fit within the lamp cap, but other shapes are not excluded. Preferably, the two parts 5A, 5B of the first heat-conducting element 5 are made from one piece of metal.

The second heat-conducting element is formed by a metal finger 7 which is connected by further means for conducting the heat, such as a heat sink. Another method of transporting the heat further will be discussed with reference to FIGS. 5-7. The finger 7 is flat at the side contacting the flange 5B, so that a good transfer of heat can be effected. The finger 7 extends into the lamp cap 4 through an aperture provided in the lamp cap in the above embodiment. Other arrangements are possible.

FIG. 2 shows, for example, a situation where there is no need for the finger 7 to extend into the lamp cap 4, as the first heat-conducting part 5 itself extends from within the lamp cap 4 through an aperture made therein. This requires the aperture to be made at another position, but apart from this the thermal effects of this configuration are comparable to those of the embodiment depicted in FIG. 1.

FIG. 3 shows a situation in which no part extends through any aperture made in the lamp cap 4, but rather the heat flow crosses the lamp cap 4 via a part 5 in intimate contact with the lamp cap at the inner side of the lamp cap and a part 7 in intimate contact with the outer surface of the lamp cap 4. Both parts 5, 7 make contact here with the same section of the lamp cap 4, or in other words, both parts 5, 7 are adjacent to the lamp cap 4, which lies in-between. In this embodiment, the first part is formed by the first metal heat-conducting part 5, and in particular the flange 5B thereof. The other part is formed by the distal end of the heat-conducting finger 7.

FIG. 4 shows an embodiment wherein the lamp cap 4 itself functions as the first metal heat-conducting element. This obviates the need for a separate part.

The lamp cap 4 is thermally connected both to the stem 3 of the lamp 1 and to a portion of the cylindrical section of the lamp envelope 2. It is noted here that it is possible to provide only one of the contacts, i.e. at the exhaust tube 3 and at the rim of the envelope 2 as referred to above. It is equally possible in the preceding embodiments described with reference to FIGS. 1-3 to achieve a contact with the rim of the glass envelope 2 instead of or as an addition to the contact at the exhaust tube 3.

The lamp cap 4 comprises for this purpose a sleeve-shaped part 5A which surrounds the exhaust tube 3. The space between the sleeve-shaped part 5A and the exhaust tube 3 is filled with a heat-conducting paste 6. Although the lamp cap 4 is also adapted to transport heat from the rim of the glass envelope 2, the lamp cap is commonly in such a good thermal contact with the rim of the glass envelope that there is no need to use a heat-conducting paste 6 between the glass envelope 2 and the lamp cap 4. Should the need arise, however, it may still be applied.

There is no finger in this embodiment to transport the heat further, rather a heat sink 8 is provided against the flat end of the lamp cap. The heat sink 8 transfers its heat to a gas flow contacting the heat sink. Such a gas flow can be generated by a construction which is the subject of a European patent application to be filed on the same day as the present application. (Attorney's docket PHNL040717).

It will be clear that al four embodiments described above comprise features which may be mutually exchanged within the scope of the present invention.

The embodiments shown in FIGS. 1, 2 and 3 all require a finger 7, which conducts the heat away from the lamp cap 4. It is noted that backlighting for displays usually requires a mutually parallel array of longitudinal lamps. This offers the possibility to arrange a heat-conducting part at one side of the array of lamps and to use a heat-conducting finger for thermal contact between the lamp caps and the heat-conducting part. Such an arrangement is depicted in FIGS. 5, 6 and 7.

FIG. 5 shows an elevational view perpendicular to the plane of the display of such an array, wherein the heat-conducting part is formed by a metal rod 10. This metal rod has a large cross-section so as to be able to conduct the heat generated by the lamps or, expressed otherwise, to maintain the required temperature at the cold spot in each of the lamps.

In the most common configuration, wherein the display is arranged vertically, or at least substantially vertically, the metal rod 10 will also extend vertically. The vertical rod is connected to each of the lamp caps 4 by a respective finger 7, so that there is a thermal connection between each of the lamp caps 4 and the metal rod 10.

As is shown in FIG. 6, which shows an elevational view of this embodiment in the direction parallel to the display, the metal rod 10 is offset relative to the axial direction of the lamps. Although not absolutely necessary, this arrangement has the advantage that the fingers extend in radial direction from the lamp caps, resulting in to less interference with the contacts arranged in the lamp caps for the supply of electric power to the lamps. It is possible, however, to use alternative arrangements, such as angled or curved fingers. Of course the heat collected by the metal rod should be transported further, for example to a heat sink or other cooling facilities, which as such do form part of the present invention.

The offset position of the metal rod 10 is clearly visible in FIG. 7, which shows a plan view of the arrangement.

The heat to be conducted away from the lamps is dependent on, among other factors, the position of the lamps. The upper lamps are generally hotter than the lower lamps.

Other effects also have to be taken into account, e.g. the presence of other heat-generating components. To take account of the different cooling requirements of the lamps, depending on their positions, the cross-sections of the fingers 7A, 7B, 7C, 7D may be different. This is clearly shown in FIG. 6, wherein the fingers 7A, 7B, 7C, 7D connecting the lamp caps 4 to the metal rod 10 have different heights. It is apparent from FIG. 5 that the widths of the fingers 7A, 7B, 7C, 7D are the same, so that their cross-sections increase with the height of the position of the lamps 2, thus meeting the different cooling requirements. This feature serves to maintain an equal temperature of the cold spot in each of the lamps 2.

The arrangement described above provides a simple control of the temperature of the lamps and in particular of the cold spots thereof. As the efficiency of the lamps is highly dependent on the temperature of the cold spot, and the overall temperature of the ambience of the lamps is not predictable, in particular after switching-on during warming-up, it may be advantageous to carry out a further temperature control of the lamps, particularly of the cold spots thereof. A first possibility is the provision of a so-called Peltier element, which is also known as a thermoelectric element, to perform a temperature-dependent control of the capacity of the cooling system. This Peltier element may be provided in a suitable location in the cooling path. However, to conform to the invention described herein, the Peltier element must be arranged in a position where a first heat-conducting element is present between the lamp itself and the Peltier element. In the embodiment depicted in FIGS. 5-7, the Peltier element may be arranged at the distal end of the metal rod 10.

FIG. 8 shows another embodiment, wherein an air gap is used to control the cooling capacity. The arrangement may again be positioned in several locations in the cooling path, an attractive location being adjacent to the lamp cap, as depicted in this Figure. A metal flange 11 is arranged in direct contact with the lamp cap 4. A metal cylinder 12 is arranged at a short distance from the metal flange 11. An air gap 13 is present between the metal flange and the metal cylinder.

The thermal path extends through the flange 11, the air gap 13, and the metal cylinder 12. The metal cylinder 12 is movable in axial direction so that the width of the air gap 13 is variable.

A bimetal part not depicted in the drawings is incorporated in the metal cylinder 12. The bimetal part is arranged such that the position of the metal cylinder 12, and thus the width of the air gap, is temperature-dependent. The arrangement is chosen such that the air gap is narrower at higher temperatures, so that the cooling capacity of the thermal path increases, while at lower temperatures the air gap is wider, resulting in a lesser cooling capacity. The capacity of the thermal path is controlled here by variation of the length of a part in the longitudinal direction. The medium of said part is air in this embodiment, but other media may equally well be used.

FIG. 9 shows a configuration wherein control of the thermal resistance takes place by adjusting the cross-section of the thermal path. This embodiment comprises an annular body 14 arranged adjacent to the metal cap 4, so that thermal resistance between the metal cap 4 and the annular body is minimized. A metal cylinder 15 is provided so as to be movable within the central aperture of the annular body 14. The fit of the cylindrical body is exact, so that a good thermal contact obtains over the full circumferential surface area of the cylindrical body. The area is dependent on the position of the cylindrical body or, to be more precise, on how far the cylindrical body is inserted into the annular body. The thermal resistance of the cooling path can be modified in that the position of the cylindrical body relative to the annular body is changed.

To make use of this property, a bimetal unit 16 is provided in the housing 17 in which the lamp cap is mounted. The bimetal unit 16 forms the connection between the cylindrical body 15 and the housing. As in the preceding arrangement, the housing functions as a heat conductor. The bimetal unit 16 will determine the position of the cylindrical body 15 in dependence on the temperature. The thermal conductivity is accordingly dependent on the temperature, thus providing the required control.

In the embodiments described above, the control unit, or bimetal unit, is arranged between the lamp cap and the housing. It thus forms an adaptation of the embodiment depicted in FIG. 4. It will be clear that temperature-controlled cooling circuits are also applicable in other embodiments described in this application. Other principles of temperature control may equally well be applied.

The preceding embodiments disclose cooling means which are in contact with the ends of the lamps, as they make contact with the exhaust tube or the rims of the cylindrical part of the glass envelope of the lamp. In some circumstances it may be advisable, for example in view of space requirements, to place the contact in a different location, for example at the intermediate part of the cylindrical section of the lamp, i.e. the part which emits the light. The use of only a small contact surface area reduces the disadvantages of screening of light emitted by the lamps. Another feature is the location the contact surface at the rear of the lamp, opposite the display unit, so that only the light emitted by the lamp towards the reflector provided at the rear is screened off to only a limited extent.

FIG. 10 is a cross-sectional view of such an arrangement. A heat-conducting element 20 is provided between the glass envelopes 2 of the lamps and the reflector 21. The reflector has a multiple function here in that it also functions as a heat sink or as a part of the cooling means. An air flow is generated behind the reflector if the reflector functions as a heat sink. It is also possible, however, that the reflector is thermally coupled to a rear wall of the housing of the apparatus in which the unit is located. Although the reflector is depicted as a flat screen, it is possible to use a profiled sheet as a reflector.

FIG. 11 depicts a situation where, contrary to the preceding embodiment, the cooling means are in contact with the ends of the lamps, in particular at the lamp caps 4. This implies that the lamp caps are thermally coupled to the parts of the lamp to be cooled, as was described with reference to FIG. 4. In FIG. 4, the lamp caps themselves are provided with heat sinks. In this embodiment, the heat sinks are formed by separate units 22 which are connected to the lamp caps 4 by clamps 23 to achieve a close contact therewith so as to allow a thermal flow from the lamp caps 4 to the heat sinks 22. In the situation depicted in FIG. 11, each of the lamp caps is connected to one heat sink only, allowing an easy application of the heat sinks and an easy adaptation of the number of heat sinks to the number of lamps and hence to the size of the display unit to be backlit.

In the depicted situation, the cooling surfaces of the heat sinks extend mutually in parallel. This renders possible the thermal connection to other heat-transporting units, such as a larger common heat sink for all lamps.

A final embodiment makes use of a metal part which extends through the glass envelope.

This embodiment is depicted in FIG. 12. This Figure shows a lamp end identical to that of FIG. 1. Parts corresponding to those depicted in FIG. 1 will not be described any further.

In the embodiment of FIG. 1, the heat generated in the lamp envelope is removed through the envelope 4. In the present embodiment, heat is conducted through a metal rod 23 extending through the stem of the lamp envelope. The rod 23 forms a cold spot within the lamp envelope 4. At its outer end the rod comprises a flange 23 which is in contact with the finger 7, so that a good thermal connection is obtained. The rod extends through the glass envelope 2. The different thermal expansion coefficients may lead to problems owing to the high temperatures. These problems are mitigated through the use of techniques known per se from the field of lead-through conductors for electrodes. This may imply the use of flat rods, or rather foils. The features of this embodiment may be combined with those of other embodiments.

It will be clear that numerous variations may be applied to the described embodiments without departing from the scope of the invention as claimed.

1. Backlight module for backlighting an LCD-display unit, comprising:
holding means for holding a number of substantially longitudinal fluorescent lamps, each of the lamps comprising a glass envelope;
supply means for energizing said lamps; and
cooling means for removing at least part of the heat developed by the lamps,
characterized in that the cooling means comprise at least a first metal heat-conducting body which is thermally coupled to the glass envelope of at least one of the lamps, and in that the cooling means are in contact with only a limited surface area of the glass envelope of said at least one lamp.

2. Module as claimed in claim 1, characterized in that
the cooling means are adapted to create a cold spot on said at least one lamp.

3. Module as claimed in claim 1, characterized in that the cooling means are connected to a metal part that extends through the lamp envelope.

4. Module as claimed in claim 3, characterized in that the cooling means are connected to the metal part located at one of the ends of the lamp envelope.

5. Module as claimed claim 1, characterized in that the glass envelope comprises an exhaust tube, and in that the cooling means are adapted to be in contact with said exhaust tube.

6. Module as claimed in claim 5, characterized in that the cooling means comprise a thermally conducting paste which is arranged between the exhaust tube of the lamp and the first metal heat-conducting body of the lamp.

7. Module as claimed in claim 5, characterized in that the first metal heat-conducting body comprises an annular body that extends around the exhaust tube and that is in contact with a second metal heat-conducting body.

8. Module as claimed in claim 7, characterized in that the first metal heat-conducting body comprises a substantially cylindrical sleeve which is open at both ends.

9. Module as claimed in claim 7, characterized in that a flange arranged coaxially with the annular body is in contact with the second metal heat-conducting body, and in that the sleeve and the flange form a unitary body.

10. Module as claimed in claim 7, characterized in that the second heat-conducting body is formed by a metal finger thermally connected to a heat-conducting rod.

11. Module as claimed in claim 9, characterized in that the secondary heat-conducting body extends through a lamp cap arranged at the end of the lamp at which a stem is located.

12. Module as claimed in claim 10, characterized in that the module comprises a plurality of lamps, and in that the envelope of each of the lamps is connected to the heat-conducting rod by means of a metal finger.

13. Module as claimed in claim 12, characterized in that the heat-conducting capacity of each of the fingers increases with the lamp temperature expected to prevail during operation.

14. Module as claimed in claim 1, characterized in that the cooling means comprise a heat sink connected to at least one of the metal lamp caps that are arranged at the respective ends of the lamp.

15. Module as claimed in claim 14, characterized in that the heat sink comprises a hollow disc extending around the lamp cap or caps.

16. Module as claimed in claim 14, characterized in that the heat sink comprises a clamp connected to the lamp cap or caps.

17. Module as claimed in claim 1, characterized in that the cooling means are arranged to be in contact with the cylindrical portion of the lamp envelope.

18. Module as claimed in claim 17, characterized in that the metal heat-conducting body forms part of a metal box in which the lamps are accommodated, and in that a heat-conducting pad is provided between each of the lamps and the respective part of the metal box.

19. Module as claimed in claim 18, characterized in that the metal box is thermally connected to at least a part of a housing of the apparatus in which the backlight unit is provided.

20. Module as claimed in claim 1, characterized in that the thermal conductance of the cooling means is dependent on the ambient temperature.

21. Module as claimed in claim 20, characterized in that the cooling means comprise a Peltier element which is connected to a control unit responsive to the ambient temperature.

22. Module as claimed in claim 20, characterized in that the cooling means comprise two heat-conducting elements that are in mutual contact via a coupling surface, and in that the thermal conductivity of the coupling surface is controllable through changing of the position of one of the elements.

23. Module as claimed in claim 22, characterized in that the cooling means comprise two heat-conducting elements that are in mutual contact via a coupling surface, and in that the surface area of the coupling surface is controllable through changing of the position of one of the elements.

24. Module as claimed in claim 22, characterized in that the cooling means comprise two heat-conducting elements which are separated by an air gap, wherein the width of the air gap is controllable through changing of the position of one of the elements.

25. Module as claimed in claim 20, characterized in that the control of the thermal conductance of the path is responsive to the ambient temperature, and in that the cooling means comprise a bimetal as a control element.

26. LCD-display unit, characterized in that it comprises a module as claimed in claim 1.

27. LCD-display unit as claimed in claim 26, characterized in that the backlight of the LCD-display is adapted to be operated in a scanning mode.

28. TV-unit, characterized in that it comprises an LCD-display unit as claimed in claim 26.

29. HCFL-lamp, characterized in that it is adapted for mounting in a module as claimed in claim 3.

30. HCFL-lamp as claimed in claim 29, characterized in that a metal part extends through the envelope, which metal part is adapted to be in contact with cooling means when mounted in a module as claimed in claim 3.
